(19) United States
(12) Patent Application Publication
(10) Pub. No.: US 2019/0310086 A1
(43) Pub. Date: Oct. 10, 2019

(54) GYROSENSOR, SIGNAL PROCESSING DEVICE, ELECTRONIC APPARATUS, AND METHOD OF CONTROLLING A GYROSENSOR

(71) Applicant: SONY CORPORATION, TOKYO (JP)

(72) Inventors: KAZUO TAKAHASHI, KANAGAWA (JP); KUNIHIKO MORI, TOKYO (JP)

(21) Appl. No.: 16/315,318

(22) PCT Filed: May 30, 2017
(86) PCT No.: PCT/JP2017/020031

§ 371 Date: Jan. 4, 2019

(30) Foreign Application Priority Data
Jul. 21, 2016 (JP) 2016-142979

(51) Int. Cl. G01C 19/5649

(52) U.S. Cl. CPC G01C 19/5649; G01C 19/5656

(57) ABSTRACT

A gyrosensor according to an embodiment of the present technology includes an oscillator and a controller. The oscillator includes an oscillator body and a detection part. The detection part is provided on the oscillator body, and outputs a detection signal including angular velocity information. The controller includes an angular-velocity detection circuit and a correction circuit. The angular-velocity detection circuit detects the detection signal in synchronization with a first timing signal. The correction circuit detects the detection signal in synchronization with a second timing signal and generates a correction signal for correcting driving of the oscillator, the second timing signal having a phase different from a phase of the first timing signal.

### TECHNICAL FIELD

The present technology relates to a gyrosensor, a signal processing device, and an electronic apparatus, which detect a rotation angular velocity of an object on the basis of an output signal from an oscillator, and a method of controlling a gyrosensor.

### BACKGROUND ART

At present, motion sensors for detecting motions of human are widely used in mobile apparatuses mainly. Above all, a gyrosensor that detects an angular velocity has been miniaturized due to progress in the MEMS (Micro Electro Mechanical Systems) technology in recent years, and various types of devices have been developed and commercialized.

In Patent Literature 1, for example, an angular velocity sensor capable of detecting angular velocities about the three axes is disclosed. The angular velocity sensor includes a rectangular and annular frame including a principal surface, a plurality of pendulum parts protruding to the center of the frame from the four corner parts of the frame, and a drive part causing the frame to oscillate in the fundamental oscillation on a plane parallel to the principal surface. In addition, the angular velocity sensor is structured to detect an angular velocity about the axis orthogonal to the principal surface on the basis of a deformation amount of the frame, and to detect angular velocities about two axes parallel to the principal surface on the basis of deformation amounts of the plurality of pendulum parts in directions orthogonal to the principal surface.

### CITATION LIST

### Patent Literature

Patent Literature 1: Japanese Patent No. 4858662

### DISCLOSURE OF INVENTION

### Technical Problem

As a gyrosensor that detects angular velocities about a plurality of axes by one sensor is miniaturized, variations in the shape and the electrode positions of the gyrosensor give relatively larger influence on the oscillation property and the angular-velocity detection property. Due to this, separating the oscillation mode is difficult, and cross-axis sensitivity is thereby produced. As a result, obtaining a desired angular-velocity detection property is difficult.

In view of the above circumstances, it is an object of the present technology to provide a gyrosensor, a signal processing device, and an electronic apparatus, which are capable of suppressing production of cross-axis sensitivity and obtaining a desired angular-velocity detection property, and a method of controlling a gyrosensor.

### Solution to Problem

A gyrosensor according to an embodiment of the present technology includes an oscillator and a controller.

The oscillator includes an oscillator body and a detection part. The detection part is provided on the oscillator body, and outputs a detection signal including angular velocity information.

The controller includes an angular-velocity detection circuit and a correction circuit. The angular-velocity detection circuit detects the detection signal in synchronization with a first timing signal. The correction circuit detects the detection signal in synchronization with a second timing signal and generates a correction signal for correcting driving of the oscillator, the second timing signal having a phase different from a phase of the first timing signal.

The correction circuit of the gyrosensor monitors an unnecessary oscillation of the oscillator and generates a correction signal for cancelling the unnecessary oscillation. Due to this, a desired oscillation property of an oscillator is maintained, and as a result, a desired angular-velocity detection property may be obtained by suppressing production of cross-axis sensitivity.

The oscillator may further include a reference part that outputs a reference signal showing an oscillation state of the oscillator body. In this case, the correction circuit is structured to detect the detection signal in synchronization with the reference signal as the second timing signal.

Due to this, an unnecessary oscillation of an oscillator may be detected accurately.

The oscillator body may include a principal surface, and the detection part may include a detection electrode that outputs a detection signal including angular velocity information about an axis parallel to the principal surface. In this case, the correction circuit detects an oscillation component in a direction in an axis orthogonal to the principal surface of the oscillator body by detecting the detection signal in synchronization with the second timing signal.

Typically, the oscillator body includes a frame being annular and including the principal surface, and a plurality of pendulum parts, one end of each of the plurality of pendulum parts being supported by the frame.

The detection part includes a first detection electrode and a second detection electrode. The first detection electrode is provided on the principal surface and outputs a first detection signal on the basis of a deformation amount of the frame on a plane parallel to the principal surface, the first detection signal including angular velocity information about a first axis orthogonal to the principal surface. The second detection electrodes are provided on the plurality of pendulum parts respectively, and each of the second detection electrodes outputs a second detection signal including angular velocity information about a second axis orthogonal to the first axis.

In this case, the correction circuit detects an oscillation component of each of the plurality of pendulum parts in the first axis direction by detecting the second detection signal in synchronization with the second timing signal.

The oscillator may further include a drive part and a plurality of auxiliary drive parts. The drive part is provided on the principal surface and oscillates the frame on a plane parallel to the principal surface. The plurality of auxiliary drive parts are provided on the plurality of pendulum parts respectively, and the correction signal is inputted in the plurality of auxiliary drive parts.

In this case, the correction circuit generates the correction signal so that the oscillation component of each of the plurality of pendulum parts becomes zero.

Alternatively, the drive part may include a plurality of auxiliary drive parts, the correction signal being inputted in the plurality of auxiliary drive parts. In this case, the correction circuit generates the correction signal so that the oscillation component of each of the plurality of pendulum parts becomes zero.

The correction circuit may be structured to detect the first detection signal in synchronization with the second timing signal.

Due to this, an unnecessary oscillation in an oscillation mode, in which an oscillator oscillates parallel to a principal surface, may be monitored.

In the above-mentioned structure, the oscillator may further include a plurality of auxiliary drive parts that are provided on the principal surface, the correction signal being inputted in the plurality of auxiliary drive parts. In the case, the first detection electrode includes a plurality of detection electrode parts, and the correction circuit generates the correction signal so that difference between outputs from the plurality of detection electrode parts becomes zero.

The second detection electrode may further output a third detection signal including angular velocity information about a third axis orthogonal to the first axis and the second axis respectively. In this case, the correction circuit further detects an oscillation component of each of the plurality of pendulum parts in the first axis direction by detecting the third detection signal in synchronization with the second timing signal.

Due to this, an oscillation leakage between the two axes may be effectively suppressed.

A signal processing device according to an embodiment of the present technology includes an angular-velocity detection circuit and a correction circuit.

The angular-velocity detection circuit detects a detection signal outputted from an oscillator in synchronization with a first timing signal for detecting an angular velocity.

The correction circuit detects the detection signal in synchronization with a second timing signal and generates a correction signal for correcting driving of the oscillator, the second timing signal having a phase different from a phase of the first timing signal.

The correction circuit may be structured to detect the detection signal in synchronization with a reference signal showing an oscillation state of the oscillator as the second timing signal.

The signal processing apparatus may further include a drive circuit that oscillates the oscillator on a plane parallel to a principal surface of the oscillator.

The detection signal may include angular velocity information about two axes parallel to the principal surface. In this case, the correction circuit detects an oscillation component of the oscillator in a direction in an axis orthogonal to the principal surface by detecting the detection signal in synchronization with the second timing signal, and generates the correction signal so that the oscillation component of the oscillator becomes zero.

The correction circuit may be structured to detect the detection signal of each axis parallel to the principal surface, and generate the correction signal individually so that the oscillation component of each axis parallel to the principal surface becomes zero.

An electronic apparatus according to an embodiment of the present technology includes a gyrosensor.

The gyrosensor includes an oscillator and a controller.

The oscillator includes an oscillator body and a detection part. The detection part is provided on the oscillator body, and outputs a detection signal including angular velocity information.

The controller includes an angular-velocity detection circuit and a correction circuit. The angular-velocity detection circuit detects the detection signal in synchronization with a first timing signal. The correction circuit detects the detection signal in synchronization with a second timing signal and generates a correction signal for correcting driving of the oscillator, the second timing signal having a phase different from a phase of the first timing signal.

A method of controlling a gyrosensor according to an embodiment of the present technology includes detecting a detection signal outputted from an oscillator in synchronization with a first timing signal for detecting an angular velocity.

the detection signal is detected in synchronization with a second timing signal having a phase different from a phase of the first timing signal.

A correction signal for correcting driving of the oscillator is generated on the basis of a detection signal, the detection signal being detected in synchronization with the second timing signal.

### Advantageous Effects of Invention

As described above, according to the present technology, production of cross-axis sensitivity may be suppressed, and a desired angular-velocity detection property may be obtained.

Note that the effects described above are not limitative, but any effect described in the present disclosure may be produced.

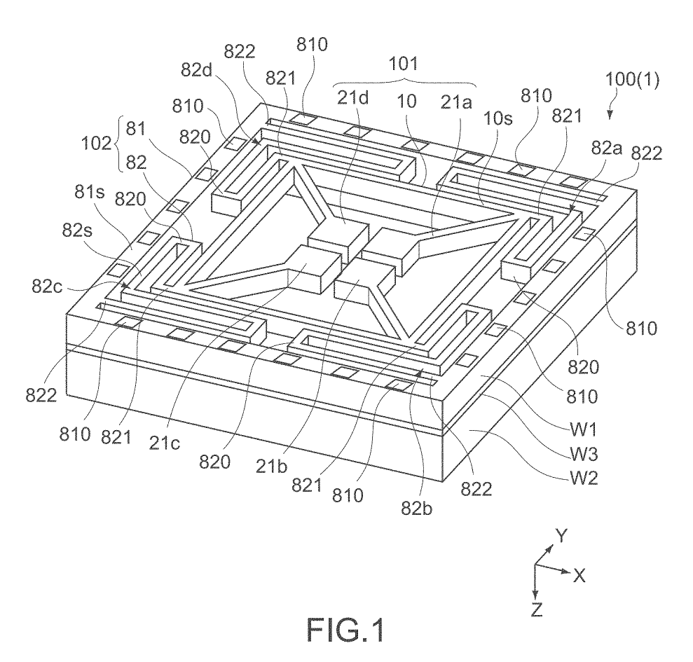

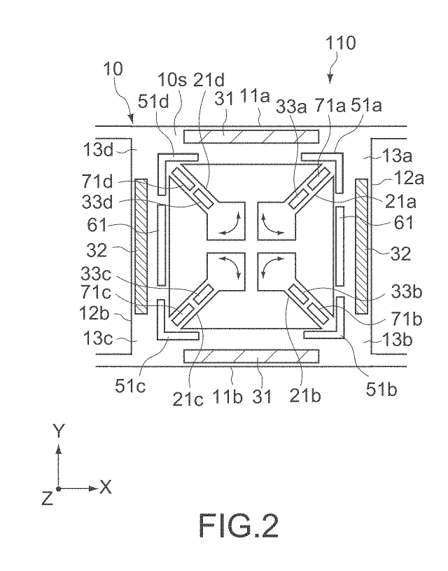

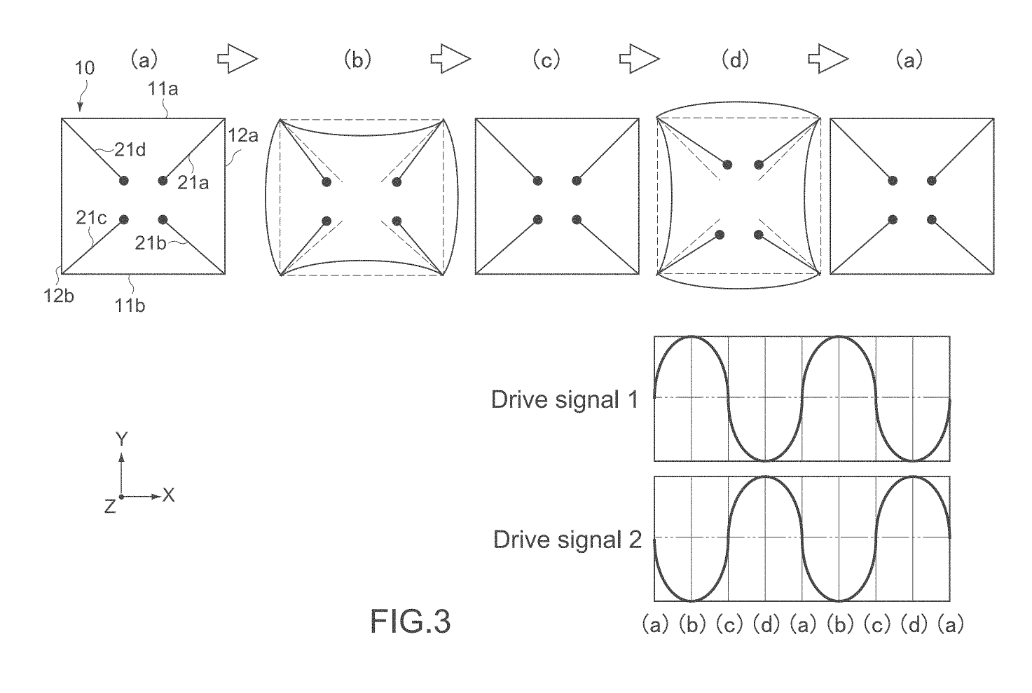

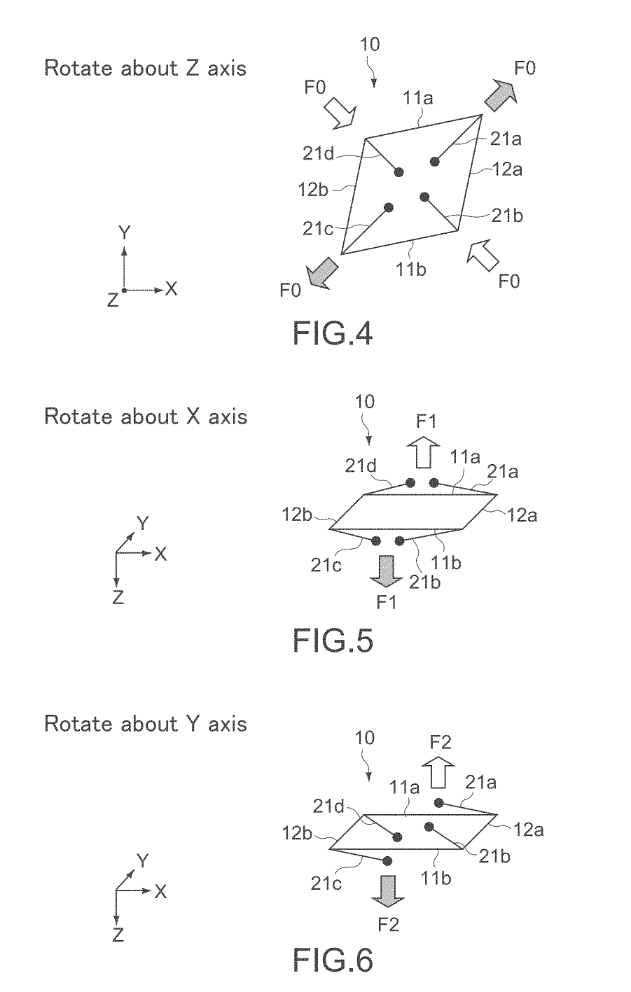

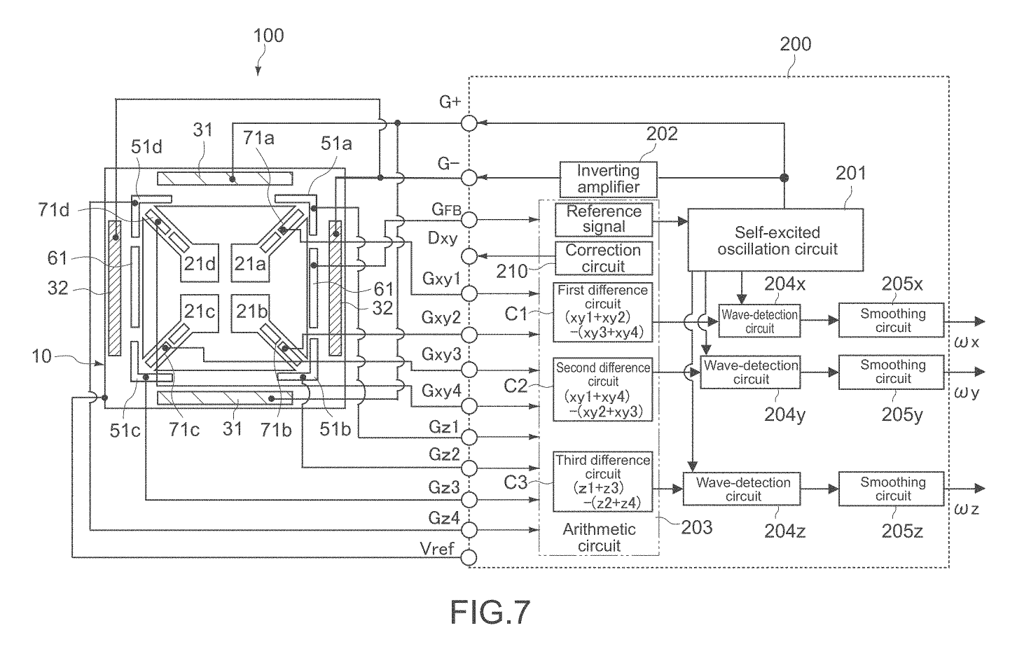

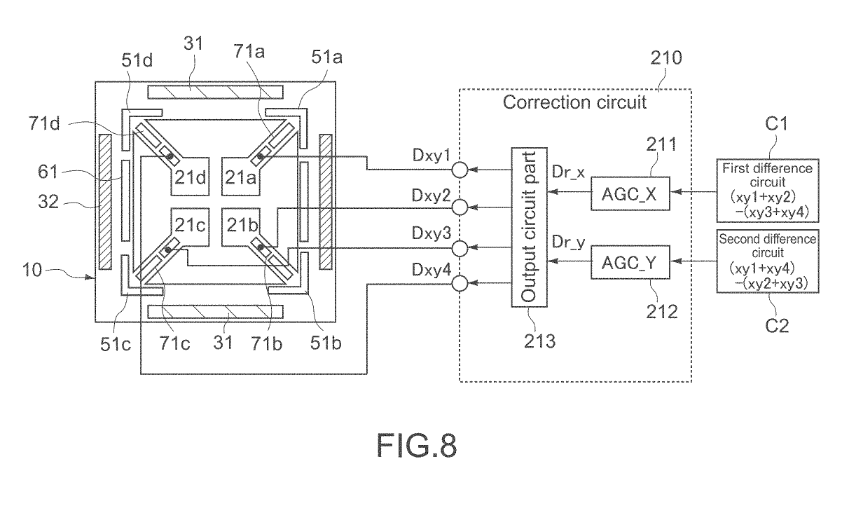

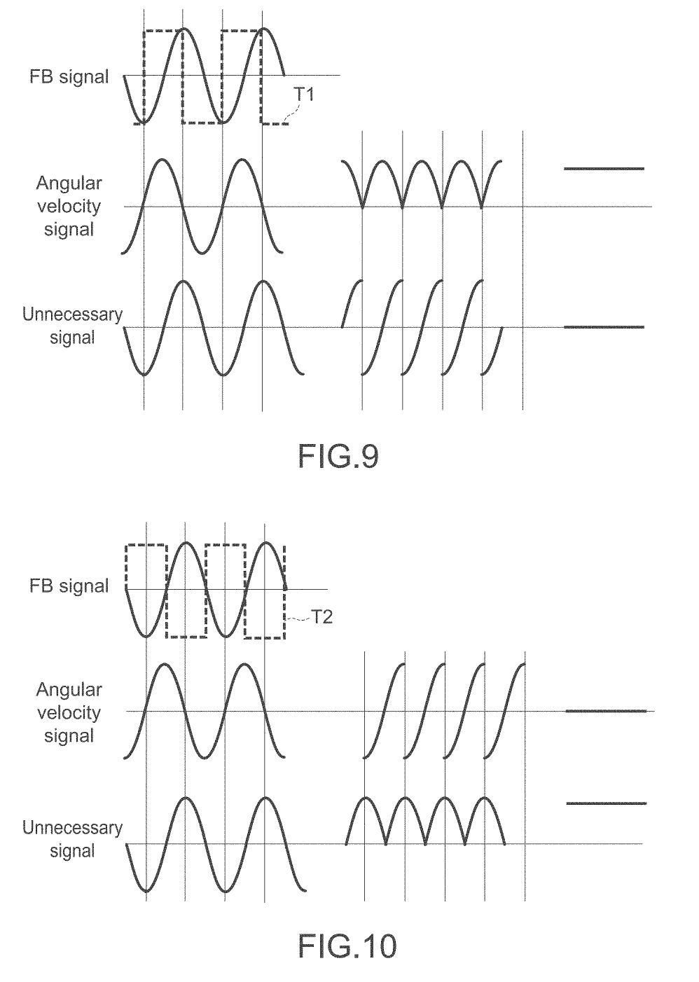

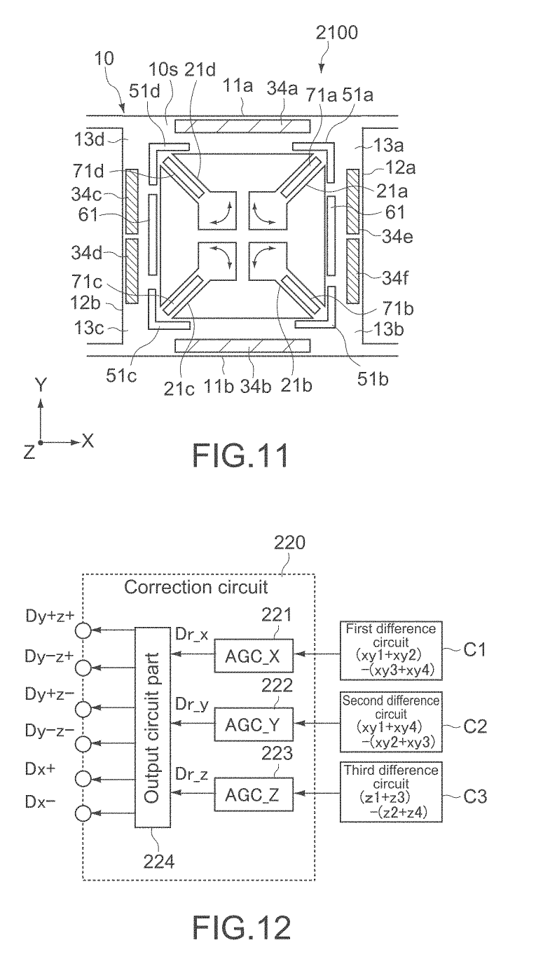

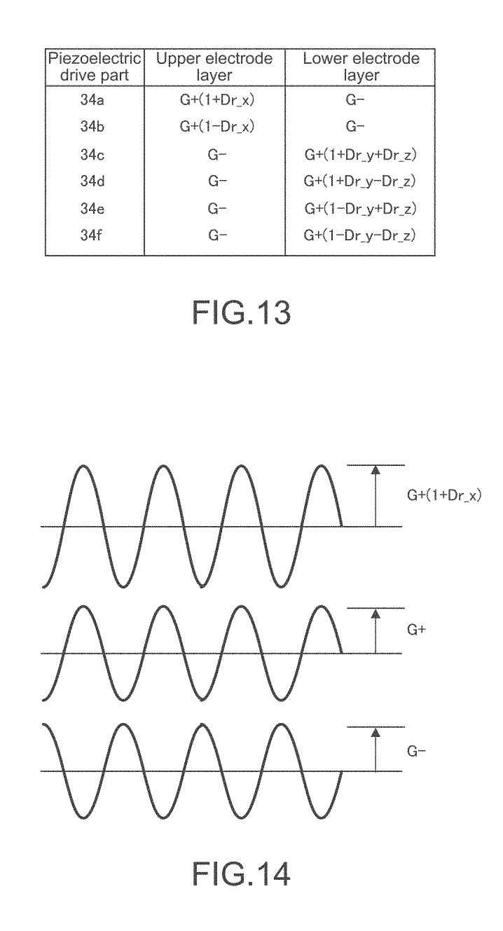

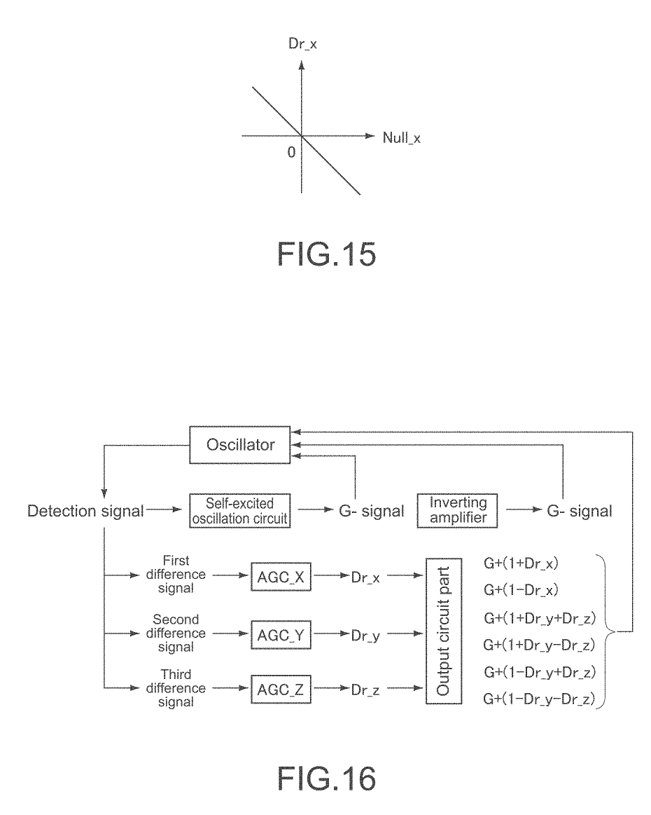

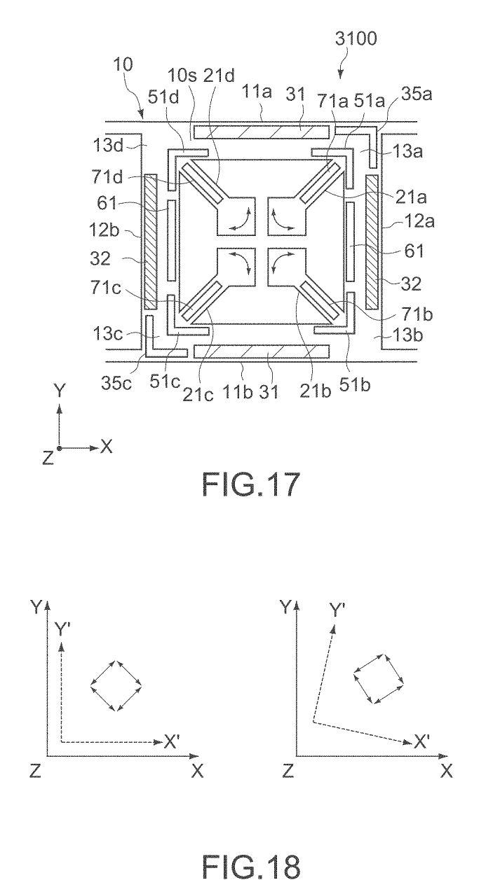

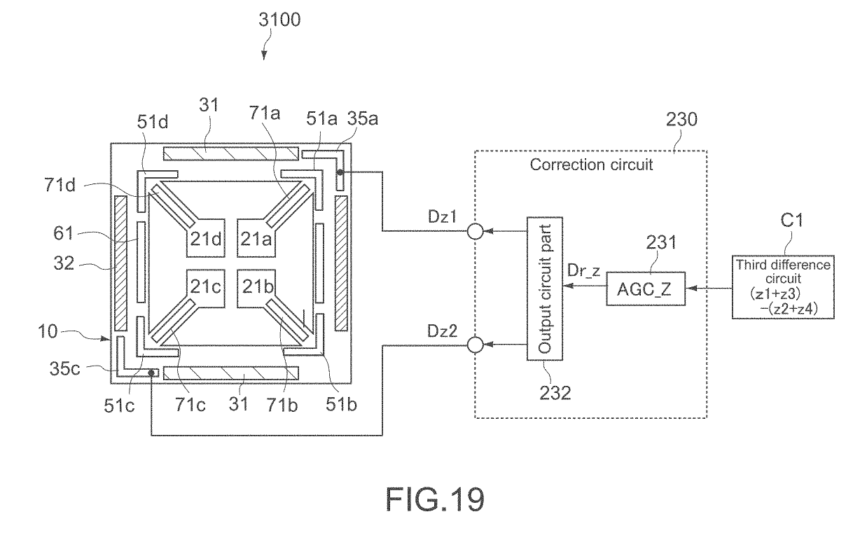

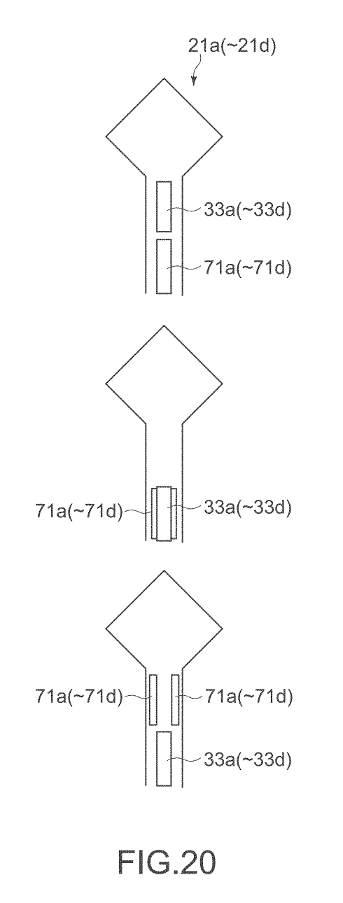

### BRIEF DESCRIPTION OF DRAWINGS

[FIG. 1] A perspective view schematically showing a structure of an oscillator of a gyrosensor according to a first embodiment of the present technology.

[FIG. 2] A plan view schematically showing a structure of an oscillator of the gyrosensor.

[FIG. 3] A diagram schematically showing a temporal change of the fundamental oscillation of the oscillator body.

[FIG. 4] A diagram schematically showing an oscillation mode when an angular velocity about the Z-axis is applied to the oscillator body.

[FIG. 5] A diagram schematically showing an oscillation mode when an angular velocity about the X-axis is applied to the oscillator body.

[FIG. 6] A diagram schematically showing an oscillation mode when an angular velocity about the Y-axis is applied to the oscillator body.

[FIG. 7] A block diagram showing a relationship between the oscillator body and a controller that is connected to the oscillator body.

[FIG. 8] A block diagram showing a structure of a correction circuit of the controller.

[FIG. 9] A diagram illustrating an action of the controller.

[FIG. 10] A diagram illustrating another action of the controller.

[FIG. 11] A plan view schematically showing a structure of an oscillator of a gyrosensor according to a second embodiment of the present technology.

[FIG. 12] A block diagram of a main part showing a structure example of a controller of the gyrosensor.

[FIG. 13] A diagram showing an example of a correction signal generated by the controller.

[FIG. 14] A diagram illustrating an example of the correction signal.

[FIG. 15] A diagram illustrating an example of the correction signal.

[FIG. 16] A diagram illustrating a generating procedure of the correction signal.

[FIG. 17] A plan view schematically showing a structure of an oscillator of a gyrosensor according to a third embodiment of the present technology.

[FIG. 18] A diagram schematically illustrating an action of the gyrosensor.

[FIG. 19] A block diagram schematically showing a structure example of a controller of the gyrosensor.

[FIG. 20] A diagram illustrating a deformation example of a structure of a main part of an oscillator according to the first embodiment.

### MODE(S) FOR CARRYING OUT THE INVENTION

Hereinafter, embodiments according to the present technology will be described with reference to the drawings.

### First Embodiment

FIG. 1 is a perspective view schematically showing a structure of an oscillator of a gyrosensor according to an embodiment of the present technology. In FIG. 1, an X-axis, a Y-axis, and a Z-axis indicate three axial directions orthogonal to each other.

In the present embodiment, a gyrosensor capable of detecting angular velocities about the three axes will be described as an example. The gyrosensor according to the present embodiment is mounted on a control board of an electronic apparatus, and detects an angular velocity applied to the electronic apparatus. Examples of the electronic apparatus include a smartphone, a video camera, a car navigation system, a game machine, and the like and, in addition, a wearable device such as a head mount display.

First, the fundamental structure of an oscillator 100 of a gyrosensor 1 will be described.

The oscillator 100 is composed of a material including single crystal silicon (Si). For example, the oscillator 100 is formed by performing fine processing on an SOI board made of two attached silicon boards, and includes an active layer W1, a support layer W2, and a bond layer (BOX (Buried-Oxide) layer) W3. The active layer W1 and the support layer W2 are composed of silicon boards, and the bond layer W3 is composed of a silicon oxide film.

The oscillator 100 includes an oscillator body 101 and a rim body 102. The oscillator body 101 and the rim body 102 are formed by performing fine processing on the active layer W1 to have a predetermined shape. The support layer W2 and the bond layer W3 are formed in a rim shape around the active layer W1. Each thickness of the active layer W1, the support layer W2, and the bond layer W3 is, for example, about 40 μm, about 300 μm, and about 1 μm, respectively.

[Oscillator Body]

FIG. 2 is a plan view schematically showing a structure of the oscillator body 101. The oscillator body 101 includes an annular frame 10 (support part), and a plurality of pendulum parts 21a, 21b, 21c, and 21d.

(Frame)

The frame 10 has a lateral direction in the X-axis (second axis) direction, a lengthwise direction in the Y-axis (third axis) direction, and a thickness direction in the Z-axis (first axis). The frame 10 includes a principal surface 10s orthogonal to the Z-axis. The respective sides of the frame 10 function as oscillation beams, and include a pair of first beams 11a and 11b and a pair of second beams 12a and 12b.

The pair of first beams 11a and 11b includes one pair of the opposite sides extending parallel to the X-axis direction and facing each other in the Y-axis direction. The pair of second beams 12a and 12b includes another pair of the opposite sides extending in the Y-axis direction and facing each other in the X-axis direction. The respective beams 11a, 11b, 12a, and 12b have the same length, width, and thickness, and cross sections of the respective beams in a longitudinal direction are formed in a substantially rectangular shape.

The size of the frame 10 is not particularly limited. For example, the length of one side of the frame 10 is 1000 to 4000 μm, the thickness of the frame 10 is 10 to 200 μm, and the width of the beams 11a, 11b, 12a, and 12b is 50 to 200 μm.

In the parts corresponding to the four corners of the frame 10, a plurality of connection parts 13a, 13b, 13c, and 13d (four parts in the present example) connecting between the pair of first beams 11a and 11b and the pair of second beams 12a and 12b are formed respectively. The both ends of the pair of first beams 11a and 11b and the both ends of the pair of second beams 12a and 12b are supported by the connection parts 13a to 13d. In other words, the respective beams 11a, 11b, 12a, and 12b function as the oscillation beams, the both ends of which are supported by the connection parts 13a to 13d.

(Pendulum Part)

The oscillator body 101 includes the plurality of pendulum parts 21a, 21b, 21c, and 21d (four parts in the present example), the structure of which is a cantilever.

The pendulum parts 21a and 21c (one pair of first pendulum parts) are formed on one pair of the connection parts 13a and 13c in the diagonal relationship respectively, and extend along the diagonal line direction (fourth axis direction crossing the X-axis direction and the Y-axis direction on a plane parallel to the principal surface 10s) inside the frame 10. Each one end of the pendulum parts 21a and 21c is supported by each of the connection parts 13a and 13c and protrudes to the center of the frame 10. The other ends of each of the pendulum parts 21a and 21c face each other in the vicinity of the center of the frame 10.

The pendulum parts 21b and 21d (one pair of second pendulum parts) are formed on the other pair of the connection parts 13b and 13d in the diagonal relationship respectively, and extend along the diagonal line direction (fifth axis direction crossing the X-axis direction, the Y-axis direction, and the fourth axis direction on the plane parallel to the principal surface 10s) inside the frame 10. Each one end of the pendulum parts 21b and 21d is supported by each of the connection parts 13b and 13d and protrudes to the center of the frame 10. The other ends of each of the pendulum parts 21b and 21d face each other in the vicinity of the center of the frame 10.

Typically, the pendulum parts 21a to 21d have the same shape and size respectively, and are formed simultaneously at the time of external shape processing of the frame 10. The shapes and sizes of the pendulum parts 21a to 21d are not particularly limited, and all of the pendulum parts 21a to 21d may not be formed in the same shape or the like.

[Rim Body]

As shown in FIG. 1, the rim body 102 includes an annular base part 81 arranged around the oscillator body 101 and a coupling part 82 arranged between the oscillator body 101 and the base part 81.

[Base Part]

The base part 81 is composed of a square rim body surrounding the outside of the oscillator body 101. The base part 81 includes a rectangular and annular principal surface 81s formed on the same plane as the principal surface 10s of the frame 10. On the principal surface 81s, a plurality of terminal parts (electrode pads) 810 electrically connected to a controller 200 (see FIG. 7) are provided. The opposite surface of the principal surface 81s is bonded to the support layer W2 via the bond layer W3. The support layer W2 is composed of the same rim body as the base part 81, and partially supports the base part 81.

The controller 200 includes a control circuit that drives the oscillator 100 and detects angular velocities about respective axes by processing output from the oscillator 100 as described below. The respective terminal parts 810 are electrically and mechanically connected on a control board on which the controller is mounted via bumps which are not shown. Note that wire bonding method may be adopted to mount the oscillator 100.

(Coupling Part)

The coupling part 82 includes a plurality of coupling parts 82a, 82b, 82c, and 82d supporting the oscillator body 101 to allow the oscillator body 101 to oscillate with respect to the base part 81. The respective coupling parts 82a to 82d extend from the respective connection parts 13a to 13d of the frame 10 to the base part 81. The coupling parts 82a to 82d include first ends 821 connected to the oscillator body 101 and second ends 822 connected to the base part 81 respectively, and are structured to be deformable mainly on the XY-plane when receiving oscillation of the frame 10. In other words, the coupling parts 82a to 82d function as suspensions supporting the oscillator body 101 to allow the oscillator body 101 to oscillate.

The coupling parts 82a to 82d have principal surfaces 82s parallel to the principal surface 10s of the frame 10 and the principal surface 81s of the base part 81 respectively. Typically, the principal surfaces 82s are on the same plane as the respective principal surfaces 10s and 81s. In other words, the coupling parts 82a to 82d according to the present embodiment are composed of the same silicon board as the silicon board composing the oscillator body 101.

Typically, the coupling parts 82a to 82d are formed in a shape symmetric about the X-axis and the Y-axis. Due to this, the deforming direction of the frame 10 on the XY-plane becomes isotropic, and high-accuracy angular velocity detection about the respective axes can be performed without producing torsion and the like of the frame 10.

The shapes of the coupling parts 82a to 82d may be linear or nonlinear. In the present embodiment, the coupling parts 82a to 82d have rotation parts 820 between the oscillator body 101 and the base part 81 respectively, the extending directions of each rotation part 820 are reversed by substantial 180° as shown in FIG. 1. Thus, by increasing the extending lengths of the respective coupling parts 82a to 82d, it is possible to support the oscillator body 101 without preventing oscillation of the oscillator body 101. In addition, an effect of not transmitting external oscillation (impact) to the oscillator body 101 may be obtained.

[Piezoelectric Drive Part]

The oscillator 100 includes a plurality of piezoelectric drive parts that oscillate the frame 10 on the XY-plane parallel to the principal surface 10s thereof.

As shown in FIG. 2, the plurality of piezoelectric drive parts include a pair of first piezoelectric drive parts 31 provided respectively on the principal surface 10s of the pair of first beams 11a and 11b and a pair of second piezoelectric drive parts 32 provided respectively on the principal surface 10s of the pair of second beams 12a and 12b. The first piezoelectric drive parts 31 and the second piezoelectric drive parts 32 mechanically deform according to an input voltage, and drive force of the deformation oscillates the beams 11a, 11b, 12a, and 12b. The deforming directions are controlled by a polarity of the input voltage.

The first piezoelectric drive parts 31 and the second piezoelectric drive parts 32 are formed straight on the top surfaces (the principal surface 10s) of the beams 11a, 11b, 12a, and 12b, and parallel to the axis line thereof, respectively. In FIG. 2, in order to understand easily, the first piezoelectric drive parts 31 and the second piezoelectric drive parts 32 are shown by each different hatching. The first piezoelectric drive parts 31 are arranged on outer edge parts of the pair of first beams 11a and 11b, and the second piezoelectric drive parts 32 are arranged on outer edge parts of the pair of second beams 12a and 12b.

The first piezoelectric drive parts 31 and the second piezoelectric drive parts 32 have the same structure. Each piezoelectric drive part has a layered structure including a lower electrode layer, a piezoelectric film, and an upper electrode layer respectively. The upper electrode layer corresponds to a first electrode-for-driving (D1) on the first piezoelectric drive part 31, and corresponds to a second electrode-for-driving (D2) on the second piezoelectric drive part 32. On the other hand, the lower electrode layer corresponds to the second electrode-for-driving (D2) on the first piezoelectric drive part 31, and corresponds to the first electrode-for-driving (D1) on the second piezoelectric drive part 32. Insulating films such as silicon oxide films are formed on the surfaces of the beams on which the respective piezoelectric drive layers are formed (the principal surface 10s).

Typically, the piezoelectric film is composed of lead zirconate titanate (PZT). The piezoelectric film is polarized and aligned in order to stretch and contract according to the potential difference between the lower electrode layer and the upper electrode layer. At this time, alternate-current voltages having opposite phases are applied to the upper electrode layer and the lower electrode layer. Due to this, the piezoelectric film may be stretched and contracted with about double amplitude compared to a case that the lower electrode layer is the common electrode.

According to the present embodiment, there is employed a structure in which first drive signals (G+) are input in the respective upper electrode layers (first electrodes-for-driving D1) of the first piezoelectric drive parts 31 respectively, and second drive signals (G−), which are differential (having opposite phases) from the drive signals (G+), are input in the lower electrode layers (second electrodes-for-driving D2) of the first piezoelectric drive parts 31 respectively. On the other hand, according to the present embodiment, there is employed a structure in which the second drive signals (G−) are input in the respective upper electrode layers (second electrodes-for-driving D2) of the second piezoelectric drive parts 32 respectively, and the first drive signals (G+) are input in the lower electrode layers (first electrodes-for-driving D1) of the second piezoelectric drive parts 32 respectively.

(Drive Principle)

Voltages having opposite phases are applied to the first piezoelectric drive parts 31 and the second piezoelectric drive parts 32 so that one contracts when the other extends. Due to this, the pair of second beams 12a and 12b are deformed and bent in the X-axis direction while the both ends are supported by the connection parts 13a to 13d, and the pair of second beams 12a and 12b oscillate alternately in directions in which the pair of second beams 12a and 12b approach and leave each other on the XY-plane. Similarly, the pair of first beams 11a and 11b are deformed and bent in the Y-axis direction while the both ends are supported by the connection parts 13a to 13d, and the pair of first beams 11a and 11b oscillate alternately in directions in which the pair of first beams 11a and 11b approach and leave each other on the XY-plane.

Thus, in a case that the pair of first beams 11a and 11b oscillate in the direction in which the pair of first beams 11a and 11b approach each other, the pair of second beams 12a and 12b oscillate in the direction in which the pair of second beams 12a and 12b leave each other. In a case that the pair of first beams 11a and 11b oscillate in the direction in which the pair of first beams 11a and 11b leave each other, the pair of second beams 12a and 12b oscillate in the direction in which the pair of second beams 12a and 12b approach each other. At this time, the center parts of the respective beams 11a, 11b, 12a, and 12b form antinodes of oscillation, and the both ends of the respective beams 11a, 11b, 12a, and 12b (connection parts 13a to 13d) form nodes of oscillation. Hereinafter, such an oscillation mode is called fundamental oscillation of the frame 10.

The beams 11a, 11b, 12a, and 12b are drived at resonance frequencies thereof. The resonance frequencies of the respective beams 11a, 11b, 12a, and 12b are determined by the shapes, lengths, and the like thereof. Typically, the resonance frequencies of the beams 11a, 11b, 12a, and 12b between the range of 1 to 100 kHz are set.

FIG. 3 is a diagram schematically showing a temporal change of the fundamental oscillation of the frame 10. In FIG. 3, “drive signal 1” shows a temporal change of the input voltage applied to the upper electrodes (first electrodes-for-driving D1) of the first piezoelectric drive parts 31, and “drive signal 2” shows a temporal change of the input voltage applied to the upper electrodes (second electrodes-for-driving D2) of the second piezoelectric drive parts 32.

As shown in FIG. 3, the drive signal 1 and the drive signal 2 have alternate-current waveshapes changing in opposite phases. Due to this, the frame 10 deforms in the order of (a), (b), (c), (d), (a) . . . , and oscillates in an oscillation mode in which one pair of the pair of first beams 11a and 11b or the pair of second beams 12a and 12b leave each other when the other pair of the pair of first beams 11a and 11b or the pair of second beams 12a and 12b approach each other, and the one pair of the pair of first beams 11a and 11b or the pair of second beams 12a and 12b approach each other when the other pair of the pair of first beams 11a and 11b or the pair of second beams 12a and 12b leave each other.

With the fundamental oscillation of the frame 10 described above, the pendulum parts 21a to 21d on the connection parts 13a to 13d being centers also oscillate on the XY-plane in synchronization with the oscillation of the frame 10 respectively. (See arrow directions shown in FIG. 2, and FIG. 3) The oscillations of the respective pendulum parts 21a to 21d are excited by the oscillations of the beams 11a, 11b, 12a, and 12b. In this case, the pendulum parts 21a and 21c oscillate (fluctuate) in opposite phases and the pendulum parts 21b and 21d oscillate (fluctuate) in opposite phases on the XY-plane in the right and left fluctuation directions from the support points of arm parts, in other words, the connection parts 13a to 13d.

As described above, by applying the alternate-current voltages having opposite phases to the first electrodes-for-driving D1 and the second electrodes-for-driving D2, the respective beams 11a, 11b, 12a, and 12b of the frame 10 oscillate in the oscillation mode shown in FIG. 3. When an angular velocity about the Z-axis is applied to the frame 10 continuing the fundamental oscillation, the frame 10 deforms on the XY-plane, for example, like warped as schematically shown in 4, since Coriolis force FO originated from the angular velocity is applied to the respect points of the frame 10, Thus, by detecting a deformation amount of the frame 10 on the XY-plane, detecting the magnitude and the direction of the angular velocity about the Z-axis applied to frame 10 may be possible.

[First Piezoelectric Detection Part]

As shown in FIG. 2, the oscillator 100 further includes a plurality of first piezoelectric detection parts 51a, 51b, 51c, and 51d. Each of the first piezoelectric detection parts 51a to 51d detects an angular velocity about the Z-axis (first axis) orthogonal to the principal surface 10s on the basis of a deformation amount of the frame 10 on the principal surface 10s. The first piezoelectric detection parts 51a to 51d include four piezoelectric detection parts provided on the principal surface 10s of the four connection parts 13a to 13d respectively.

The first piezoelectric detection parts 51a and 51c are formed around one pair of the connection parts 13a and 13c in the diagonal relationship respectively. The one piezoelectric detection part 51a thereof extends from the connection part 13a in the two directions along the beams 11a and 12a, and the other piezoelectric detection part 51c thereof extends from the connection part 13c in the two directions along the beams 11b and 12b.

Similarly, the first piezoelectric detection parts 51b and 51d are formed around the other pair of connection parts 13b and 13d in the diagonal relationship respectively. The one piezoelectric detection part 51b thereof extends from the connection part 13b in the two directions along the beams 11b and 12a, and the other piezoelectric detection part 51d thereof extends from the connection part 13d in the two directions along the beams 11a and 12b.

The first piezoelectric detection parts 51a to 51d have the similar structures to the structures of the first piezoelectric drive parts 31 and the second piezoelectric drive parts 32. In other words, each of the first piezoelectric detection parts 51a to 51d has a layered structure including a lower electrode layer, a piezoelectric film, and an upper electrode layer. The first piezoelectric detection parts 51a to 51d have functions to convert mechanical deformation of the respective beams 11a, 11b, 12a, and 12b to electric signals. The respective lower electrode layers of the first piezoelectric detection parts 51a to 51d are connected to reference potentials (V_{ref}) such as a ground potential, and the respective upper electrode layers include first electrodes-for-detecting (S1) that output detection signals (z1, z2, z3, and z4) respectively.

In the present embodiment, the respective first piezoelectric detection parts 51a to 51d provided on the frame 10 function as a plurality of detection electrode parts (first detection electrodes) that output first detection signals including angular velocity information about the Z-axis.

As shown in FIG. 2, when an angular velocity about the Z-axis is applied to the oscillator body 101, the sizes of interior angles of the frame 10 periodically vary as shown in FIGS. 3 and 4. At this time, the interior angles of one pair of the connection parts 13a and 13c in the diagonal relationship and the interior angles of the other pair of the connection parts 13b and 13d in the diagonal relationship vary in opposite phases. Thus, the output from the piezoelectric detection part 51a on the connection part 13a is theoretically the same as the output from the piezoelectric detection part 51c on the connection part 13c, and the output from the piezoelectric detection part 51b on the connection part 13b is theoretically the same as the output from the piezoelectric detection part 51d on the connection part 13d. As a result, by calculating the difference between the sum of outputs from the two piezoelectric detection parts 51a and 51c and the sum of outputs from the two piezoelectric detection parts 51b and 51d, detecting the magnitude and the direction of the angular velocity about the axis applied to the frame 10 may be possible.

[Second Piezoelectric Detection Part]

On the other hand, as shown in FIG. 2, the oscillator 100 includes a plurality of second piezoelectric detection parts 71a, 71b, 71c, and 71d as detection parts that detect an angular velocity about the X-axis and an angular velocity about the Y-axis. The second piezoelectric detection parts 71a to 71d detect angular velocities in two directions in two axes orthogonal to the Z-axis (for example, X-axis and Y-axis directions) on the basis of the deformation amounts of the plurality of arm parts 21a to 21d in the Z-axis direction. The second piezoelectric detection parts 71a to 71d include four piezoelectric detection parts provided on the four pendulum parts 21a to 21d respectively.

The second piezoelectric detection parts 71a to 71d are arranged on the axis centers on surfaces of the respective pendulum parts 21a to 21d (same surfaces as the principal surface 10s). Each of the second piezoelectric detection parts 71a to 71d has the similar structure to the structure of each of the first piezoelectric detection parts 51a to 51d and has a layered structure including a lower electrode layer, a piezoelectric film, and an upper electrode layer. The second piezoelectric detection parts 71a to 71d have functions to convert mechanical deformation of the respective pendulum parts 21a to 21d to electric signals. The respective lower electrode layers of the second piezoelectric detection parts 71a to 71d are connected to the reference potentials (V_{ref}) such as a ground potential, and the respective upper electrode layers include second electrodes-for-detecting (S2) that output detection signals (xy1, xy2, xy3, and xy4) respectively.

In the present embodiment, the respective second piezoelectric detection parts 71a to 71d provided on the arm parts 21a to 21d function as a plurality of detection electrode parts (second detection electrodes and third detection electrodes) that output second detection signals and third detection signals including angular velocity information about the X-axis and angular velocity information about the Y-axis.

For example, as schematically shown in FIG. 5, when an angular velocity about the X-axis is applied to the frame 10 oscillating in the fundamental oscillation, the Coriolis force F1 in the directions orthogonal to the oscillation directions at the moment is produced to the respective pendulum parts 21a to 21d respectively. Due to this, one pair of the pendulum parts 21a and 21d adjacent in the X-axis direction deform in the positive direction of the Z-axis by the Coriolis force F1, and the deformation amounts thereof are detected by the piezoelectric detection parts 71a and 71d respectively. Moreover, the other pair of pendulum parts 21b and 21c adjacent in the X-axis direction deform in the negative direction of the Z-axis by the Coriolis force F1, and the deformation amounts thereof are detected by the piezoelectric detection parts 71b and 71c respectively.

Similarly, when an angular velocity about the Y-axis is applied to the frame 10 oscillating in the fundamental oscillation, Coriolis force F2 in the directions orthogonal to the oscillation directions at the moment is produced to the respective pendulum parts 21a to 21d respectively as schematically shown in FIG. 6. Due to this, one pair of the pendulum parts 21a and 21b adjacent in the Y-axis direction deform in the positive direction of the Z-axis by the Coriolis force F2, and the deformation amounts thereof are detected by the piezoelectric detection parts 71a and 71b respectively. Moreover, the other pair of pendulum parts 21c and 21d adjacent in the Y-axis direction deform in the negative direction of the Z-axis by the Coriolis force F2, and the deformation amounts thereof are detected by the piezoelectric detection parts 71c and 71d respectively.

Moreover, in a case that an angular velocity about an axis in a direction obliquely crossing the X-axis and the Y-axis respectively is produced, the angular velocity is detected on the basis of the similar principle described above. In other words, each of the pendulum parts 21a to 21d is deformed by the Coriolis force according to the X-direction component and the Y-direction component of the angular velocity, and the deformation amounts of the pendulum parts 21a to 21d are detected by the piezoelectric detection parts 71a to 71d respectively. The controller extracts an angular velocity about the X-axis and an angular velocity about the Y-axis respectively on the basis of outputs from the piezoelectric detection parts 71a to 71d. Due to this, detecting an angular velocity about an arbitrary axis parallel to the XY-plane may be possible.

[Reference Electrode]

As shown in FIG. 2, the oscillator 100 includes reference electrodes 61 (reference parts). The reference electrodes 61 are arranged adjacent to the second piezoelectric drive parts 32 on the beam 12a and the beam 12b. Each of the reference electrodes 61 has the similar structure to the structure of each of the first and second piezoelectric detection parts 51a to 51d and 71a to 71d, and has a layered structure including a lower electrode layer, a piezoelectric film, and an upper electrode layer. The reference electrodes 61 have functions to convert mechanical deformation of the beam 12a and the beam 12b to electric signals. The lower electrode layer is connected to the reference potential such as a ground potential, and the upper electrode layer functions as an electrode-for-detecting that outputs a reference signal (FB signal). The reference signal is used as an oscillation monitor signal showing an oscillation state of the oscillator 100.

Note that, instead of forming the reference electrodes 61, generating sum signals of the respective outputs from the first piezoelectric detection parts 51a to 51d and using the sum signals thereof as the reference signals may also be possible.

[Auxiliary Drive Part]

The oscillator 100 includes a plurality of auxiliary drive parts 33a, 33b, 33c, and 33d. The auxiliary drive parts 33a to 33d are structured to be capable of deforming the pendulum parts 21a to 21d in the Z-axis direction by inputting correction signals from the controller 200 described below.

The auxiliary drive parts 33a to 33d are arranged on the axis centers on the surfaces of the respective pendulum parts 21a to 21d (the same surfaces as the principal surface 10s). The auxiliary drive parts 33a to 33d are arranged nearer to the sides of the tips of the pendulum parts 21a to 21d than the second piezoelectric detection parts 71a to 71d are. Each of the auxiliary drive parts 33a to 33d has the similar structure to the structure of each of the piezoelectric drive parts 31 and 32, and has a layered structure including a lower electrode layer, a piezoelectric film, and an upper electrode layer. The respective lower electrode layers of the auxiliary drive parts 33a to 33d are connected to the reference potentials (V_{ref}) such as a ground potential, and the respective upper electrode layers include electrodes-for-correcting in which correction signals (D_{xy1}, D_{xy2}, D_{xy3}, and D_{xy4}) are input respectively.

The auxiliary drive parts 33a to 33d are formed straight along axis lines on the surfaces of the pendulum parts 21a to 21d, and nearer to the sides of the tips (free ends) of the pendulum parts 21a to 21d than the second piezoelectric detection parts 71a to 71d are. Due to this, oscillations of the pendulum parts 21a to 21d along the Z-axis direction may be effectively suppressed by slight piezoelectric drive force.

[Controller]

Next, the controller 200 (signal processing circuit) will be described. FIG. 7 is a block diagram showing a structure of the controller 200.

The controller 200 includes a self-excited oscillation circuit 201, an angular-velocity detection circuit (arithmetic circuit 203, wave-detection circuits 204, smoothing circuits 205, and the like), and a correction circuit 210.

The self-excited oscillation circuit 201 generates drive signals that oscillate the oscillator body 101 (frame 10 and pendulum parts 21a to 21d) on the XY-plane. As described below, the angular-velocity detection circuit generates and outputs angular velocities about the X-axis, the Y-axis, and the Z-axis on the basis of the detection signals (z1, z2, z3, z4, xy1, xy2, xy3, and xy4) outputted from the oscillator body 101. As described below, the correction circuit 210 detects an unnecessary oscillation of the oscillator 100, and generates a correction signal that cancels the unnecessary oscillation thereof.

The controller 200 includes a G+ terminal, a G-terminal, a G_{FB} terminal, a D_{xy} terminal, a G_{xy}1 terminal, a G_{xy}2 terminal, a G_{xy}3 terminal, a G_{xy}4 terminal, a G_{z}1 terminal, a G_{z}2 terminal, a G_{z}3 terminal, a G_{z}4 terminal, and a V_{ref} terminal.

Note that the G_{z}1 terminal and the G_{z}3 terminal may be a common terminal, and the G_{z}2 terminal and the G_{z}4 terminal may be a common terminal. In this case, a wire, which is integrated halfway, is connected to the G_{z}1 terminal and the G_{z}3 terminal, and a wire, which is integrated halfway, is connected to the G_{z}2 terminal and the G_{z}4 terminal.

In the present embodiment, the G+ terminal is electrically connected to the upper electrode layers of the first piezoelectric drive parts 31 and the lower electrode layers of the second piezoelectric drive parts 32 respectively. The G− terminal is electrically connected to the lower electrode layers of the first piezoelectric drive parts 31 and the upper electrode layers of the second piezoelectric drive parts 32 (electrodes-for-driving D2) respectively. The G_{FB} terminal is electrically connected to the upper electrode layers of the reference electrodes 61 respectively.

The G+ terminal is connected to an output end of the self-excited oscillation circuit 201. The G− terminal is connected to the output end of the self-excited oscillation circuit 201 via an inverting amplifier 202. The self-excited oscillation circuit 201 includes a drive circuit that generates drive signals (alternate-current signals) for driving the first piezoelectric drive parts 31 and the second piezoelectric drive parts 32. The inverting amplifier 202 generates drive signals (second drive signals G−), the sizes of which are the same as the drive signals generated in the self-excited oscillation circuit 201 (first drive signals G+), and the phases of which are inverted by 180° compared to the drive signals generated in the self-excited oscillation circuit 201 (first drive signals G+). The drive signals G+are controlled in order that the reference signal is constant. Due to this, the first piezoelectric drive parts 31 and the second piezoelectric drive parts 32 are stretched and contracted in opposite phases. Note that, in order to understand easily, in FIG. 7, connections between the lower electrode layers of the respective piezoelectric drive parts 31 and 32, and the controller 200 are omitted.

The G_{xy}1 terminal, the G_{xy}2 terminal, the G_{xy}3 terminal, and the G_{xy}4 terminal are electrically connected to the upper electrode layers of the second piezoelectric detection parts 71a, 71b, 71c, and 71d (second electrodes-for-detecting S2) respectively. The G_{z}1 terminal, the G_{z}2 terminal, the G_{z}3 terminal, and the G_{z}4 terminal are electrically connected to the upper electrode layers of the piezoelectric detection parts 51a, 51b, 51c, and 51d (first electrodes-for-detecting S1) respectively. The V_{ref} terminal is electrically connected to the lower electrode layers of the reference electrodes 61, and the lower electrode layers of the first piezoelectric detection parts 51a to 51d, the second piezoelectric detection parts 71a to 71d, and the auxiliary drive parts 33a to 33d respectively.

The G_{FB} terminal, the G_{xy}1 terminal, the G_{xy}2 terminal, the G_{xy}3 terminal, the G_{xy}4 terminal, the G_{z}1 terminal, the G_{z}2 terminal, the G_{z}3 terminal, and the G_{z}4 terminal are connected to an input end of the arithmetic circuit 203 respectively. The arithmetic circuit 203 includes a first difference circuit C1 for generating an angular velocity signal about the X-axis, a second difference circuit C2 for generating an angular velocity signal about the Y-axis, and a third difference circuit C3 for generating an angular velocity signal about the Z-axis.

Outputs from the first piezoelectric detection parts 51a to 51d (Null signals) are referred to as z1 to z4 respectively, and outputs from the second piezoelectric detection parts 71a to 71d (Null signals) are referred to as xy1 to xy4 respectively. At this time, the first difference circuit C1 calculates ((xy1+xy2)−(xy3+xy4)), and outputs the calculated value as a first difference signal to a wave-detection circuit 204x. The second difference circuit C2 calculates ((xy1+xy4)−(xy2+xy3)), and outputs the calculated value as a second difference signal to a wave-detection circuit 204y. Further, the third difference circuit C3 calculates ((z1+z3)−(z2+z4)), and outputs the calculated value as a third difference signal to a wave-detection circuit 204z.

The wave-detection circuits 204x, 204y, and 204z detect the first difference signal in synchronization with a first timing signal for detecting an angular velocity, and perform DC conversion. In the present embodiment, a signal, the phase of which is shifted by a predetermined phase amount (for example, 90°) from the phase of the reference signal (FB) that is outputted from the reference electrode 61, is used as the first timing signal. The smoothing circuits 205x, 205y, and 205z smooth the outputs from the wave-detection circuits 204x, 204y, and 204z. A direct-current voltage signal cox outputted from the smoothing circuit 205x includes angular velocity information about a magnitude and a direction of an angular velocity about the X-axis, and a direct-current voltage signal coy outputted from the smoothing circuit 205y includes angular velocity information about a magnitude and a direction of an angular velocity about the Y-axis. Similarly, a direct-current voltage signal ωz outputted from the smoothing circuit 205z includes angular velocity information about a magnitude and a direction of an angular velocity about the Z-axis. In other words, the magnitudes of the direct-current voltage signals ωx, ωy and ωz to the reference potential V_{ref} correspond to information about magnitudes of angular velocities, and the polarities of the direct-current voltage signals correspond to information about directions of the angular velocities.

The correction circuit 210 detects the second difference signal in synchronization with a second timing signal having a phase different from the phase of the first timing signal, and performs DC conversion. A signal, the phase of which is different from the phase of the first timing signal by 90°, is used as the second timing signal, and in the present embodiment, the signal that is synchronized with the reference signal (FB) outputted from the reference electrode 61 is used. The correction circuit 210 includes a smoothing circuit smoothing a wave-detection signal, and detects magnitudes of unnecessary oscillations of the pendulum parts 21a to 21d.

Here, the unnecessary oscillation means an oscillation component in the direction outside a plane that deforms the pendulum parts 21 to 21d in the Z-axis direction regardless of whether an angular velocity is produced or not. Since the unnecessary oscillation produces an angular velocity signal (false signal) showing as if the angular velocity would be produced when an angular velocity about the X-axis or the Y-axis is not produced, the unnecessary oscillation may be a factor in deterioration of angular-velocity-detection accuracy, production of cross-axis sensitivity, or the like. Since the correction circuit 210 detects a detection signal (difference signal) in synchronization with a timing signal different from the timing signal for detecting an angular velocity, the correction circuit 210 may detect whether or not an oscillation of the component in the Z-axis direction of the pendulum parts 21a to 21b is produced and the magnitude of the oscillation of the component in the Z-axis direction of the pendulum parts 21a to 21b, regardless of whether an angular velocity is produced or not.

The correction circuit 210 further generates a correction signal for correcting driving of the oscillator 100, on the basis of the magnitude of an unnecessary oscillation detected by the correction circuit 210. The correction signal is optimized for each of the pendulum parts 21a to 21d in order to be allowed to cancel an unnecessary oscillation of the oscillator 100. The correction signals generated by the correction circuit 210 are inputted to the respective auxiliary drive parts 33a to 33d on the pendulum parts 21a to 21d via the D_{xy} terminals respectively.

FIG. 8 is a block diagram illustrating the correction circuit 210. The correction circuit 210 includes an X-axis-adjust circuit part 211, a Y-axis-adjust circuit part 212, and an output circuit part 213.

The X-axis-adjust circuit part 211 determines a correction coefficient (Dr_x), which makes an unnecessary oscillation component producing a false angular velocity signal about the X-axis to be zero, on the basis of the output from the first difference circuit C1 (first difference signal). The Y-axis-adjust circuit part 212 determines a correction coefficient (Dr_y), which makes an unnecessary oscillation component producing a false angular velocity signal about the Y-axis to be zero, on the basis of the output from the second difference circuit C2 (second difference signal). Each of the adjust circuit parts 211 and 212 includes an AGC (Auto Gain Controller) circuit that automatically adjusts gain and keeps an output level constant.

The output circuit part 213 outputs the correction signals, which are generated on the basis of the outputs from the respective adjust circuit parts 211 and 212, to the respective auxiliary drive parts 33a to 33d via the D_{xy} terminals (D_{xy}1 terminal, D_{xy}2 terminal, D_{xy}3 terminal, and D_{xy}4 terminal). The correction signal is a voltage signal, and produces piezoelectric drive force, which makes each of unnecessary oscillation components of the pendulum parts 21a to 21d (the same phase component as FB signal) to be zero, on the auxiliary drive parts 33a to 33d.

[Operation of Gyrosensor]

Next, a typical operation of the gyrosensor 1 structured as described above according to the present embodiment will be described.

The oscillator body 101 is supported by the base part 81 via the coupling parts 82a to 82d, and the piezoelectric drive parts 31 and 32 oscillate the frame 10 and the plurality of pendulum parts 21a to 21d on a plane parallel to the principal surface 10s in synchronization with each other.

In this state, when an angular velocity about the Z-axis is applied to the frame 10, the frame 10 deforms on a plane parallel to the principal surface 10s since the Coriolis force in the directions orthogonal to the oscillation directions at the moment is produced in the frame 10 (See FIG. 4). The first piezoelectric detection parts 51a to 51d output detection signals corresponding to the angular velocity about the Z-axis on the basis of the deformation amount of the frame 10.

On the other hand, when an angular velocity about the X-axis or the Y-axis is applied to the frame 10, the plurality of pendulum parts 21a to 21d deform in directions orthogonal to the principal surface 10s since the Coriolis force in the directions orthogonal to the oscillation directions at the moment is produced in the plurality of pendulum parts 21a to 21d (See FIGS. 5 and 6). The second piezoelectric detection parts 71a to 71d output detection signals corresponding to the angular velocity about the X-axis or the Y-axis on the basis of the deformation amounts of the pendulum parts.

The controller 200 detects the angular velocity signals about the Z-axis, the X-axis, and the Y-axis (ωz, ωx, and ωy) and the unnecessary oscillation signals of the pendulum parts 21a to 21d respectively, on the basis of the detection signals from the first piezoelectric detection parts 51a to 51d (z1 to z4) and the detection signals from the second piezoelectric detection parts 71a to 71d (xy1 to xy4).

FIG. 9 is a timing chart showing a method of detecting angular velocity signals about the X-axis and the Y-axis, and FIG. 10 is a timing chart showing a method of detecting unnecessary oscillation signals of the pendulum parts 21a to 21d. In each of the FIGS. 9 and 10, the left diagram shows a waveshape of a detection signal before detecting the detection signal in synchronization, the center diagram shows a waveshape of the detection signal after detecting the detection signal in synchronization, and the right diagram shows a waveshape of the detection signal after smoothing the detection signal respectively.

As shown in FIG. 9, the controller 200 detects an angular velocity signal by detecting the first difference signal in synchronization with a first timing signal T1. The phase of the angular velocity signal is shifted by 90° from the phase of the reference signal (FB signal), and the angular velocity signal is outputted. By detecting the first difference signal in synchronization with the first timing signal T1, the phase of which is shifted by 90° from the phase of the reference signal, the angular velocity signal about the X-axis or the angular velocity signal about the Y-axis applied to the oscillator 100 is detected respectively. At this time, since an unnecessary oscillation signal is in synchronization with the reference signal, the output of the unnecessary oscillation signal after detecting the first difference signal in synchronization with the first timing signal T1 is zero.

Next, as shown in FIG. 10, the controller 200 detects an unnecessary oscillation signal of the oscillator 100 (pendulum parts 21a to 21d) by detecting the second difference signal in synchronization with a second timing signal T2. The unnecessary oscillation signal is outputted in synchronization with the reference signal (the same phase as the phase of the reference signal). By detecting the second difference signal in synchronization with the second timing signal T2 that is in synchronization with the reference signal, whether or not an unnecessary oscillation of the oscillator 100 is produced or the magnitude of the unnecessary oscillation of the oscillator 100 is detected. Note that the output of the angular velocity signal after detecting the second difference signal in synchronization with the second timing signal T2 is zero.

As described above, the angular velocity signal and the unnecessary oscillation signal are separated respectively, and are detected. The angular velocity signals about the respective axes and the unnecessary oscillation signal are detected for the respective axes independently.

The controller 200 further generates a correction signal that corrects driving of the oscillator 100 (pendulum parts 21a to 21d), on the basis of the output from the second difference signal, which is detected in synchronization with the second timing signal T2.

As shown in FIG. 8, the correction circuit 210 determines the correction signal Dr_x, which cancels an unnecessary oscillation component producing a false angular velocity signal about the X-axis, in the X-axis-adjust circuit part 211. The correction circuit 210 determines the correction coefficient Dr_y, which cancels an unnecessary oscillation component producing a false angular velocity signal about the Y-axis, in the Y-axis-adjust circuit part 212. Further, the correction circuit 210 outputs the correction signals that are optimized for each of the plurality of auxiliary drive parts 33a to 33d to the respective auxiliary drive parts 33a to 33d via the D_{xy} terminals (D_{xy}1 terminal, D_{xy}2 terminal, D_{xy}3 terminal, and D_{xy}4 terminal), on the basis of the outputs from the respective adjust circuit parts 211 and 212. Unnecessary oscillations of the respective pendulum parts 21a to 21d in the Z-axis direction are suppressed by piezoelectric driving of the auxiliary drive parts 33a to 33d. The correction circuit 210 continuously executes correction of deriving of the auxiliary drive parts 33a to 33d in order that the unnecessary oscillation components of the pendulum parts 21a to 21d are zero.

As described above, an angular velocity sensor 1 according to the present embodiment is structured to monitor an unnecessary oscillation of the oscillator 100 and generate the correction signal for cancelling the unnecessary oscillation. Due to this, a desired oscillation property of the oscillator 100 is maintained, and as a result, a desired angular-velocity detection property may be obtained by suppressing production of cross-axis sensitivity.

### Second Embodiment

FIG. 11 is a plan view schematically showing a structure of an oscillator 2100 of a gyrosensor according to a second embodiment of the present technology. Hereinafter, structures different from the structures of the first embodiment are mainly described, and the similar reference symbols are attached to the structures similar to the structures of the first embodiment. Besides, the descriptions thereof are omitted or simplified.

The oscillator 2100 includes piezoelectric drive parts 34a to 34f that oscillate the frame 10 on a plane parallel to the principal surface 10s, and the piezoelectric drive parts 34a to 34f also have a function as a plurality of auxiliary drive parts in which correction signals for cancelling an outside-a-plane oscillation component of the frame 10 (unnecessary oscillation component) are inputted.

In the present embodiment, the piezoelectric drive parts 34a and 34b are provided on the beams 11a and 11b in place of the first piezoelectric drive parts 31, and the piezoelectric drive electrodes 34c to 34f are provided in place of the second piezoelectric drive parts 32 respectively. The piezoelectric drive parts 34c and 34d make a pair, and are arranged straight on the outer circular side of the principal surface 10s of the beam 12b. The piezoelectric drive parts 34e and 34f make a pair, and are arranged straight on the outer circular side of the principal surface 10s of the beam 12a.

Each of the piezoelectric drive parts 34a to 34f has the same structure, and has a layered structure including a lower electrode layer, a piezoelectric film, and an upper electrode layer. The piezoelectric drive parts 34a to 34f are structured such that corrected drive signals that are corrected (first drive signals G+ and correction signals) are inputted in the upper electrode layers of the piezoelectric drive parts 34a and 34b and the lower electrode layers of the piezoelectric drive parts 34c to 34f respectively, and the second drive signals G− are inputted in the lower electrode layers of the piezoelectric drive parts 34a and 34b and the upper electrode layers of the drive electrodes 34c to 34f respectively (See FIG. 13).

The gyrosensor of the present embodiment is structured to be capable of cancelling an unnecessary oscillation component of each axis of the oscillator 2100 and maintaining a desired on-plane oscillation by the drive signals that are inputted to the piezoelectric drive parts 34a to 34f.

FIG. 12 is a block diagram showing a structure of a correction circuit 220 of the present embodiment. The correction circuit 220 includes an X-axis-adjust circuit part 221, a Y-axis-adjust circuit part 222, a Z-axis-adjust circuit part 223, and an output circuit part 224.

The X-axis-adjust circuit part 221 determines the correction coefficient (Dr_x), which makes an unnecessary oscillation component producing a false angular velocity signal about the X-axis to be zero, on the basis of the output from the first difference circuit C1 (first difference signal). The Y-axis-adjust circuit part 222 determines the correction coefficient (Dr_y), which makes an unnecessary oscillation component producing a false angular velocity signal about the Y-axis to be zero, on the basis of the output from the second difference circuit C2 (second difference signal). The Z-axis-adjust circuit part 223 determines a correction coefficient (Dr_z), which makes an unnecessary oscillation component producing a false angular velocity signal about the Z-axis to be zero, on the basis of the output from the third difference circuit C3 (third difference signal). Similarly to the first embodiment, the respective correction coefficients are calculated by detecting the difference signal of each axis in synchronization with the second timing signal (reference signal).

The output circuit part 224 outputs the correction signals, which are generated on the basis of the outputs from the respective adjust circuit parts 221 to 223, to the respective piezoelectric drive parts 34a to 34f via the D_{xy} terminals (D_{y+z+} terminal, D_{y-z+} terminal, D_{y+z-} terminal, D_{y-z-} terminal, Dₓ₊ terminal, and Dₓ₋ terminal). The correction signal is a voltage signal, and produces drive force, which makes the unnecessary oscillation component of each axis of the oscillator 2100 to be zero, on the piezoelectric drive parts 34a to 34f. FIG. 13 shows an example of the signals which are inputted to the upper electrode layers and the lower electrode layers of the respective piezoelectric drive parts 34a to 34f.

As shown in FIG. 13, the drive signals, which are inputted to the upper and lower electrode layers of the respective piezoelectric drive parts 34a to 34f, are different in the phases thereof by 180° with each other, and the magnitudes (amplitudes) thereof are also different from each other according to the magnitudes of the unnecessary oscillation components. In addition, each of the correction signal inputted to the respective piezoelectric drive parts 34a to 34f has a unique value adjusted on the basis of the correction coefficient of each axis. Thus, the magnitudes of the drive signals, which are inputted to the respective piezoelectric drive parts 34a to 34f, are different from each other, and the drive force harmonized by the respective piezoelectric drive parts 34a to 34f realizes a desired on-plane oscillation of the frame 10.

In the present embodiment, an unnecessary oscillation component in the X-axis direction is cancelled by the drive signals inputted to the piezoelectric drive parts 34a and 34b. On the other hand, unnecessary oscillation components in the Y-axis direction and the Z-axis direction are cancelled by the drive signals inputted to the piezoelectric drive parts 34c to 34f.

In the upper diagram of FIG. 14, as an example, an input-waveshape of a drive signal inputted to the upper electrode layer of the piezoelectric drive part 34a (G+(1+Dr_x)) is shown. The drive signal has an amplitude obtained by adding the drive signal (G+) shown in the central diagram of FIG. 14 to the product of the drive signal (G+) and the correction coefficient (Dr_x). On the other hand, the drive signal (G−) shown in the lower diagram of FIG. 14 is inputted to the lower electrode layer of the piezoelectric drive part 34a. As shown in FIG. 15, the correction coefficient (Dr_x) is set for a value, the quantity of which is the same as an unnecessary oscillation in the X-axis direction (Null_x) detected by detecting the first difference signal in synchronization with the second timing signal (reference signal) (Null_x), and the sign of which is different from the sign of the unnecessary oscillation in the X-axis direction (Null_x).

Note that the piezoelectric drive part 34b facing the piezoelectric drive part 34a in the Y-axis direction is different from the piezoelectric drive part 34a in that a drive signal (G+(1−Dr_x)) is inputted to the upper electrode layer of the piezoelectric drive part 34b. Thus, by inputting the asymmetric drive signals to the piezoelectric drive parts 34a and 34b, the unnecessary oscillation along the X-axis direction of the frame 10 (Null_x) is cancelled.

On the other hand, unnecessary oscillation components in the Y-axis direction and the Z-axis direction are cancelled by inputting asymmetric drive signals to the dual-structured piezoelectric drive parts 34c to 34f provided on the second beams 12a and 12b. Due to this, the respective beams 12a and 12b may oscillate in an oscillation mode in which unnecessary oscillations in the Y-axis and the Z-axis directions may be cancelled.

The correction coefficient cancelling an unnecessary oscillation of each axis is determined individually for each axis. FIG. 16 shows an example of a control flow of cancelling an unnecessary oscillation.

First, the frame 10 is oscillated in the fundamental-oscillation mode by inputting the initial values of the drive signals (G+and G−) to the respective piezoelectric drive parts 34a to 34f.

Then the correction coefficient (Dr_x) that cancels the unnecessary oscillation in the X-axis direction (Null_x) is determined on the basis of the difference signal of outputs from the second piezoelectric detection parts 71a to 71d (first difference signal), and the correction signals which are individually generated on the basis of operation expressions shown in FIG. 13 are inputted to the piezoelectric drive parts 34a and 34b respectively.

Next, the correction coefficient (Dr_y) that cancels an unnecessary oscillation in the Y-axis direction (Null_y) is determined on the basis of the difference signal of outputs from the second piezoelectric detection parts 71a to 71d (second difference signal), and the correction signals which are individually generated on the basis of the operation expressions shown in FIG. 13 are inputted to the piezoelectric drive parts 34c to 34f respectively.

Last, the correction coefficient (Dr_z) that cancels an unnecessary oscillation in the Z-axis direction (Null_z) is determined on the basis of the difference signal of outputs from the first piezoelectric detection parts 51a to 51d (third difference signal), and the correction signals which are individually generated on the basis of the operation expressions shown in FIG. 13 are inputted to the piezoelectric drive parts 34c to 34f respectively.

As described above, in the present embodiment as well, the similar action and effect to the action and effect of the first embodiment described above may be obtained. Particularly, according to the present embodiment, since an unnecessary oscillation of each axis of the oscillator 2100 may be cancelled, a desired oscillation property of the oscillator 2100 may be maintained. As a result, suppressing production of cross-axis sensitivity and an improvement in an angular-velocity detection property may be achieved.

### Third Embodiment

FIG. 17 is a plan view schematically showing a structure of an oscillator 3100 of a gyrosensor according to a third embodiment of the present technology. Hereinafter, structures different from the structures of the first embodiment are mainly described, and the similar reference symbols are attached to the structures similar to the structures of the first embodiment. Besides, the descriptions thereof are omitted or simplified.

The oscillator 3100 of the present embodiment includes a plurality of auxiliary drive parts 35a and 35c in which correction signals for cancelling an unnecessary oscillation component on a plane of the frame 10 are inputted. The auxiliary drive parts 35a and 35c are provided on the principal surface 10s of the frame 10 respectively.

The auxiliary drive parts 35a and 35c are formed on one pair of the connection parts 13a and 13c in the diagonal relationship and on the outer sides of the first piezoelectric detection parts 51a and 51c respectively. The one auxiliary drive part 35a thereof extends from the connection part 13a in the two directions along the beams 11a and 12a, and the other auxiliary drive part 35c thereof extends from the connection part 13c in the two directions along the beams 11b and 12b.

Each of the auxiliary drive parts 35a and 35c has the similar structure to the structure of each of the first piezoelectric drive parts 31 and the second piezoelectric drive parts 32. In other words, each of the auxiliary drive parts 35a and 35c has a layered structure including a lower electrode layer, a piezoelectric film, and an upper electrode layer, and has a function to convert input voltage of a correction signal to mechanical deformation of each of the beams 11a, 11b, 12a, and 12b. Each of the lower electrode layers of the auxiliary drive parts 35a and 35c is connected to the reference potential (V_{ref}) such as a ground potential, and each of the upper electrode layers of the auxiliary drive parts 35a and 35c includes a drive electrode in which the correction signal is inputted.

The gyrosensor of the present embodiment is structured to be capable of cancelling an unnecessary oscillation component in an on-plane direction of the oscillator 3100 and maintaining a desired on-plane oscillation by the correction signals that are inputted to the auxiliary drive parts 35a and 35c.

As shown in the left diagram of FIG. 18, for example, the oscillator 3100 is designed to perform the fundamental oscillation in a state of the respective beams of the frame 10 being aligned in the X-axis direction and the Y-axis direction. However, as shown in the right diagram of FIG. 18, the frame 10 sometimes rotates about the Z-axis due to asymmetry of the shape of the frame 10, positional deviations of the piezoelectric detection part and the piezoelectric drive part, and the like. As a result, the respective beams thereof oscillate in a state of the respective beams thereof being deviated in the X-axis direction and the Y-axis direction. In this case, cross-axis sensitivity may be produced, and a desired angular-velocity detection property may not be obtained.

Thus, in the present embodiment, such an oscillation attitude of the frame 10 is rectified, and correction signals needed for causing the frame 10 to oscillate in the ideal attitude shown in the left diagram of FIG. 18 are inputted to the auxiliary drive parts 35a and 35c.

FIG. 19 is a block diagram showing a structure of a correction circuit 230 of the present embodiment. The correction circuit 230 includes a Z-axis-adjust circuit part 231, and an output circuit part 232.

The Z-axis-adjust circuit part 231 determines the correction coefficient (Dr_z), which makes an unnecessary oscillation component producing a false angular velocity signal about the Z-axis to be zero, on the basis of the output from the third difference-calculate circuit C3 (third difference signal) calculating the difference between the detection signals of the first piezoelectric detection parts 51a to 51d. Similarly to the first embodiment, the correction coefficient (Dr_z) is calculated by detecting the third difference signal in synchronization with the second timing signal (reference signal).

The output circuit part 232 outputs the correction signals, which are generated on the basis of the output from the Z-axis-adjust circuit part 231, to the respective auxiliary drive parts 35a and 35c via a D_{z}1 terminal and a D_{z}2 terminal. The correction signal is a voltage signal, and produces drive force, which makes the difference between the detection signals of the first piezoelectric detection parts 51a to 51d to be zero, on the auxiliary drive parts 35a and 35c.

Typically, each of the correction signals inputted to the auxiliary drive parts 35a and 35c is the same voltage signal. Since the auxiliary drive parts 35a and 35c are in the diagonal relationship on the frame 10, an appropriate oscillation attitude of the frame 10 (left diagram of FIG. 18) may be realized by applying voltages to the two auxiliary drive parts 35a and 35c.

As described above, in the present embodiment as well, the similar action and effect to the action and effect of the first embodiment described above may be obtained. Particularly, according to the present embodiment, since a desired fundamental-oscillation mode of the oscillator 3100 may be maintained, suppressing production of cross-axis sensitivity and an improvement in an angular-velocity detection property may be achieved.

The embodiments of the present technology are described above, but the present technology is not limited to the above embodiments. Various modifications may be, of course, added to the embodiments.

For example, in the first embodiment described above, the auxiliary drive parts 33a to 33d that suppress unnecessary oscillations in the Z-axis direction of the pendulum parts 21a to 21 are provided on the surfaces of the pendulum parts 21a to 21d. The arrangement form of the auxiliary drive parts 33a to 33d is not limited to the arrangement form in which each of the auxiliary drive parts 33a to 33d is arranged coaxially with each of the second piezoelectric detection parts 71a to 71d as shown in the upper diagram of FIG. 20. As shown in the central diagram of FIG. 20, each of the auxiliary drive parts 33a to 33d may be layered on the side of the lower layer of each of the second piezoelectric detection parts 71a to 71d via an appropriate insulating layer. Moreover, as shown in the lower diagram of FIG. 20, a plurality of each of the auxiliary drive parts 33a to 33d may be arranged at an interval in the width direction of each of the pendulum parts 21a to 21d in parallel.

In addition, in the third embodiment described above, the auxiliary drive parts 35a and 35c, which are provided on one pair of the connection parts 13a and 13c in the diagonal relationship, are structured as auxiliary drive parts. However, instead of the pair of the connection parts 13a and 13c, auxiliary drive parts may be provided on the other pair of the connection part 13b and 13d. Moreover, auxiliary drive parts may be provided on all of the connection part 13a to 13d respectively.

Further, in the respective embodiments described above, the descriptions have been made by taking a three-axes-integrated-type angular-velocity sensor as an example. However, the present technology is applicable to a two-axes-integrated-type angular-velocity sensor, or a single-axis-type angular-velocity sensor. The form of an oscillator is also not particularly limited, and various oscillators such as a tuning-fork-type oscillator or a cantilever-type oscillator is also applicable.

Note that the present technology may also employ the following configurations.

(1) A gyrosensor, including:

an oscillator including an oscillator body and a detection part that is provided on the oscillator body, and outputs a detection signal including angular velocity information; and

a controller including an angular-velocity detection circuit that detects the detection signal in synchronization. with a first timing signal and a correction circuit that detects the detection signal in synchronization with a second timing signal and generates a correction signal for correcting driving of the oscillator, the second timing signal having a phase different from a phase of the first timing signal.

(2) The gyrosensor according to (1), in which

the oscillator further includes a reference part that outputs a reference signal showing an oscillation state of the oscillator body, and

the correction circuit detects the detection signal in synchronization with the reference signal as the second timing signal.

(3) The gyrosensor according to (1) or (2), in which

the oscillator body includes a principal surface,

the detection part includes a detection electrode that outputs a detection signal including angular velocity information about an axis parallel to the principal surface, and

the correction circuit detects an oscillation component a direction in an axis orthogonal to the principal surface of the oscillator body by detecting the detection signal in synchronization with the second timing signal.

(4) The gyrosensor according to any one of (3), in which

the oscillator body includes

a frame being annular and including the principal surface, and

a plurality of pendulum parts, one end of each of the plurality of pendulum parts being supported by the frame,

the detection part includes

a first detection electrode that is provided on the principal surface and outputs a first detection signal on the basis of a deformation amount of the frame on a plane parallel to the principal surface, the first detection signal including angular velocity information about a first axis orthogonal to the principal surface, and

second detection electrodes provided on the plurality of pendulum parts respectively, each of the second detection electrodes outputting a second detection signal including angular velocity information about a second axis orthogonal to the first axis, and

the correction circuit detects an oscillation component of each of the plurality of pendulum parts in the first axis direction by detecting the second detection signal in synchronization with the second timing signal.

(5) The gyrosensor according to (4), in which

the oscillator further includes

a drive part that is provided on the principal surface and oscillates the frame on a plane parallel to the principal surface, and

a plurality of auxiliary drive parts provided on the plurality of pendulum parts respectively, the correction signal being inputted in the plurality of auxiliary drive parts, and

the correction circuit generates the correction signal so that the oscillation component of each of the plurality of pendulum parts becomes zero.

(6) The gyrosensor according to (4), in which

the oscillator includes a drive part that is provided on the principal surface and oscillates the frame on the plane parallel to the principal surface,

the drive part includes a plurality of auxiliary drive parts, the correction signal being inputted in the plurality of auxiliary drive parts, and

the correction circuit generates the correction signal so that the oscillation component of each of the plurality of pendulum parts becomes zero.

(7) The gyrosensor according to (4), in which

the correction circuit detects the first detection signal in synchronization with the second timing signal.

(8) The gyrosensor according to (7), in which

the oscillator further includes a plurality of auxiliary drive parts that are provided on the principal surface, the correction signal being inputted in the plurality of auxiliary drive parts,

the first detection electrode includes a plurality of detection electrode parts, and

the correction circuit generates the correction signal so that difference between outputs from the plurality of detection electrode parts becomes zero.

(9) The gyrosensor according to any one of (4) to (8), in which

the second detection electrode further outputs a third detection signal including angular velocity information about a third axis orthogonal to the first axis and the second axis respectively, and

the correction circuit further detects an oscillation component of each of the plurality of pendulum parts in the first axis direction by detecting the third detection signal in synchronization with the second timing signal.

(10) A signal processing device, including:

an angular-velocity detection circuit that detects a detection signal outputted from an oscillator in synchronization with a first signal; and

a correction circuit that detects the detection signal in synchronization with a second timing signal and generates correction signal for correcting driving of the oscillator, the second timing signal having a phase different from a phase of the first timing signal.

(11) The signal processing device according to (10), in which

the correction circuit detects the detection signal in synchronization with a reference signal showing an oscillation state of the oscillator as the second timing signal.

(12) The signal processing device according to (10) or (11), further including

a drive circuit that oscillates the oscillator on a plane parallel to a principal surface of the oscillator.

(13) The signal processing device according to (12), in which

the detection signal includes angular velocity information about two axes parallel to the principal surface, and

the correction circuit detects an oscillation component of the oscillator in a direction in an axis orthogonal to the principal surface by detecting the detection signal in synchronization with the second timing signal, and generates the correction signal so that the oscillation component of the oscillator becomes zero.

(14) The signal processing device according to (13), in which

the correction circuit detects the detection signal of each axis parallel to the principal surface, and generates the correction signal individually so that the oscillation component of each axis parallel to the principal surface becomes zero.

(15) An electronic apparatus, including:

an oscillator including an oscillator body and a detection part that is provided on the oscillator body, and outputs a detection signal including angular velocity information; and

a controller including an angular-velocity detection circuit that detects the detection signal in synchronization with a first timing signal and a correction circuit that detects the detection signal in synchronization with a second timing signal and generates a correction signal for correcting driving of the oscillator, the second timing signal having a phase different from a phase of the first timing signal.

(16) A method of controlling a gyrosensor, including:

detecting a detection signal outputted from an oscillator in synchronization with a first timing signal for detecting an angular velocity;

detecting the detection signal in synchronization with a second timing signal having a phase different from a phase of the first timing signal; and

generating a correction signal for correcting driving of the oscillator on the basis of a detection signal, the detection signal being detected in synchronization with the second timing signal.

### REFERENCE SIGNS LIST

1 angular velocity sensor
10 frame
21a to 21d pendulum part
31, 32 piezoelectric drive part
33a to 33d, 34a to 34f, 35a, 35c auxiliary drive part
51a to 51d first piezoelectric detection part
71a to 71d second piezoelectric detection part
100, 2100, 3100 oscillator
200 controller
210, 220, 230 correction circuit

1. A gyrosensor, comprising:
an oscillator including an oscillator body and a detection part that is provided on the oscillator body, and outputs a detection signal including angular velocity information; and
a controller including an angular-velocity detection circuit that detects the detection signal in synchronization with a first timing signal and a correction circuit that detects the detection signal in synchronization with a second timing signal and generates a correction signal for correcting driving of the oscillator, the second timing signal having a phase different from a phase of the first timing signal.

2. The gyrosensor according to claim 1, wherein
the oscillator further includes a reference part that outputs a reference signal showing an oscillation state of the oscillator body, and
the correction circuit detects the detection signal in synchronization with the reference signal as the second timing signal.

3. The gyrosensor according to claim 1, wherein
the oscillator body includes a principal surface,
the detection part includes a detection electrode that outputs a detection signal including angular velocity information about an axis parallel to the principal surface, and
the correction circuit detects an oscillation component in a direction in an axis orthogonal to the principal surface of the oscillator body by detecting the detection signal in synchronization with the second timing signal.

4. The gyrosensor according to claim 3, wherein
the oscillator body includes
a frame being annular and including the principal surface, and
a plurality of pendulum parts, one end of each of the plurality of pendulum parts being supported by the frame,
the detection part includes
a first detection electrode that is provided on the principal surface and outputs a first detection signal on a basis of a deformation amount of the frame on a plane parallel to the principal surface, the first detection signal including angular velocity information about a first axis orthogonal to the principal surface, and
second detection electrodes provided on the plurality of pendulum parts respectively, each of the second detection electrodes outputting a second detection signal including angular velocity information about a second axis orthogonal to the first axis, and
the correction circuit detects an oscillation component of each of the plurality of pendulum parts in the first axis direction by detecting the second detection signal in synchronization with the second timing signal.

5. The gyrosensor according to claim 4, wherein
the oscillator further includes
a drive part that is provided on the principal surface and oscillates the frame on a plane parallel to the principal surface, and
a plurality of auxiliary drive parts provided on the plurality of pendulum parts respectively, the correction signal being inputted in the plurality of auxiliary drive parts, and
the correction circuit generates the correction signal so that the oscillation component of each of the plurality of pendulum parts becomes zero.

6. The gyrosensor according to claim 4, wherein
the oscillator includes a drive part that is provided on the principal surface and oscillates the frame on the plane parallel to the principal surface,
the drive part includes a plurality of auxiliary drive parts, the correction signal being inputted in the plurality of auxiliary drive parts, and
the correction circuit generates the correction signal so that the oscillation component of each of the plurality of pendulum parts becomes zero.

7. The gyrosensor according to claim 4, wherein
the correction circuit detects the first detection signal in synchronization with the second timing signal.

8. The gyrosensor according to claim 7, wherein
the oscillator further includes a plurality of auxiliary drive parts that are provided on the principal surface, the correction signal being inputted in the plurality of auxiliary drive parts,
the first detection electrode includes a plurality of detection electrode parts, and
the correction circuit generates the correction signal so that difference between outputs from the plurality of detection electrode parts becomes zero.

9. The gyrosensor according to claim 4, wherein
the second detection electrode further outputs a third detection signal including angular velocity information about a third axis orthogonal to the first axis and the second axis respectively, and
the correction circuit further detects an oscillation component of each of the plurality of pendulum parts in the first axis direction by detecting the third detection signal in synchronization with the second timing signal.

10. A signal processing device, comprising:
an angular-velocity detection circuit that detects detection signal outputted from an oscillator in synchronization with a first timing signal; and
a correction circuit that detects the detection signal in synchronization with a second timing signal and generates a correction signal for correcting driving of the oscillator, the second timing signal having a phase different from a phase of the first timing signal.

11. The signal processing device according to claim 10, wherein
the correction circuit detects the detection signal in synchronization with a reference signal showing an oscillation state of the oscillator as the second timing signal.

12. The signal processing device according to claim 10, further comprising
a drive circuit oscillating the oscillator on a plane parallel to a principal surface of the oscillator.

13. The signal processing device according to claim 12, wherein
the detection signal includes angular velocity information about two axes parallel to the principal surface, and
the correction circuit detects an oscillation component of the oscillator in a direction in an axis orthogonal to the principal surface by detecting the detection signal in synchronization with the second timing signal, and generates the correction signal so that the oscillation component of the oscillator becomes zero.

14. The signal processing device according to claim 13, wherein
the correction circuit detects the detection signal of each axis parallel to the principal surface, and generates the correction signal individually so that the oscillation component of each axis parallel to the principal surface becomes zero.

15. An electronic apparatus, comprising:
an oscillator including an oscillator body and a detection part that is provided on the oscillator body, and outputs a detection signal including angular velocity information; and
a controller including an angular-velocity detection circuit that detects the detection signal in synchronization with a first timing signal and a correction circuit that detects the detection signal in synchronization with a second timing signal and generates a correction signal for correcting driving of the oscillator, the second timing signal having a phase different from a phase of the first timing signal.

16. A method of controlling a gyrosensor, comprising:
detecting a detection signal outputted from an oscillator in synchronization with a first timing signal for detecting an angular velocity;
detecting the detection signal in synchronization with a second timing signal having a phase different from a phase of the first timing signal; and
generating a correction signal for correcting driving of the oscillator on a basis of a detection signal, the detection signal being detected in synchronization with the second timing signal.
